(19) United States
(12) Patent Application Publication
(10) Pub. No.: US 2007/0087163 A1
(43) Pub. Date: Apr. 19, 2007

(54) Self-draining floor mat with no-return flow Valve

(76) Inventor: Brian Lasly, Elma, NY (US)

Correspondence Address: PATRICIA M. COSTANZO;PATS PENDING, P.O. BOX 101, ELMA, NY, 14059, US

(21) Appl. No.: 11/252,962

(22) Filed: Oct. 18, 2005

(51) Int. Cl. B32B 3/10

(52) U.S. Cl. 428/131

(57) ABSTRACT

A no-return flow, self-draining, floor mat, comprising a mat with a no-return flow valve drain and a method for making is taught. The drain, emanating from an aperture in the mat, is positioned to pass through the floor for gravity-flow drainage of liquid and debris to the exterior. The no-return flow valve comprises a valve body having a back-flow prevention means and eliminates the need for a cap over the drain. The mat is usable in automobiles, trucks, and other vehicles with, or without, a floor divider mound, mobile and other homes. The mat is resistant to microbes and may additionally contain an anti-microbial substance to further reduce any growth of bacteria, mold, or mildew. The mat may contain a slow-release air freshener and is made of pliable material for a tight fit with a vehicle floor. The floor may be made by a molding technique from rubber or plastic.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates generally to a floor mat for a floor, such as a floor of a vehicle, and more particularly to a floor mat having a drain fitted with no-return valve draining to outside of the floor.

The background information discussed below is presented to better illustrate the novelty and usefulness of the present invention. This background information is not admitted prior art.

Floor mats are common vehicle accessories. Besides being used as a decorative feature, floor mats serve to protect the floor of a vehicle and to absorb noise. When water, snow, ice, salt, and/or other debris are brought into a vehicle, which is especially likely to happen during inclement weather, floor mats are used in an attempt to protect vehicle floors by containing the debris within the confines of the floor mat. Moreover, in today's “eat on the run” world, cups of coffee, water, soda, and the like are frequently brought into a vehicle to be ingested while driving. When the vehicle is brought to a sudden stop, it is not unusual for some of the liquid to end up on the floor of the vehicle. Although floor mats presently serve to protect the vehicle carpeting, they are likely to become stained, moldy, and mildewed from being wet for prolonged periods. Accumulations of water, salt, and other debris are likely to deteriorate the mat and deteriorate and/or corrode vehicle surfaces in proximity to the floor mat. Moreover, the presence of mold and mildew that almost inevitably occur on surfaces that remain wet for extended periods of time causes an unpleasant appearance in addition to an unpleasant odor. Presently available floor mats have a carpeted surface or are comprised of rubber or plastic, all of which are prone to deterioration when repeatedly exposed to water, salt, and debris. A more serious problem that can result from the repeated or prolonged presence of moisture on a floor, especially on the metal floor of vehicles, is rusting and general corrosion. Owners of older vehicles, especially those owners who reside in areas prone to freeze and thaw phenomena, know that the salt that is used to keep roads ice free is the cause of “floor rot”. Some people take great pride in maintaining their vehicles for a decade or more, but a rotting floor, due to the presence of salty water or other debris, can quickly ruin such aspirations. Old car enthusiasts would greatly appreciate a way to reduce the corrosion caused by the salty water brought into their vehicles by the shoes of both driver and passengers.

There have been many attempts to provide for means to keep the floors of vehicles clean and dry. Similarly, there have also been repeated attempts to provide for a method to remove the accumulated water, melted ice/snow and debris from the mat to outside of the vehicle. The danger of exhaust fumes coming into the vehicle requires a means that provides for discharge of unwanted liquid from the floor of a vehicle while providing for the means to prevent any type of back flow, either solid, gaseous, or liquid, from entering the vehicle.

One attempt at solving the problem of providing for a built in drain which also protects the vehicle's occupant from back-flow of fumes, water, and cold and hot air from outside of the vehicle offers an insertable vehicle floor drain that can be installed through floor coverings and multiple floor panels of a vehicle body. This drain, however, calls for a drain plug that must be removed to allow liquid to drain off. After the liquid is drained, the plug must be reinserted into the drain opening. This is an inconvenient solution because it periodically requires the cap to be manually removed for drainage and replaced. If the plug is not removed in a timely manner, water may still sit in the insulation. If the removal and/or reinsertion is done while the vehicle is moving, an accident may occur. If the plug is removed and not reinserted the back-flow could produce a fatal danger if the back-flow consists of exhaust fumes.

Another attempt teaches a floor mat containing a drain for directing fluid from the footwear of the driver (or passenger) down into a collecting trough or sump at the rear of the mat. When the collecting trough or sump is full, the fluid is drawn off into a closed storage tank which is connected to the floor mat by a tube connection which has quick disconnect means for separating the storage tank from the mat so that the tank may be removed and emptied when necessary. This apparatus is inconvenient because it does not allow the liquid to drain from the vehicle and requires the draining tank to be periodically emptied by the user, which may be difficult, if not impossible, for older or incapacitated persons to achieve. In any event, having to empty such a tank during wet and/or cold weather conditions would be an unpleasant task, yet during those times the tank would have to be emptied most often.

Such a self-draining floor mat would also be of great benefit to any type of floor, where the floor is susceptible to being flooded with water. Such floors may be found in industrial situations, in commercial buildings, and in homes and house trailers that live in storm prone areas.

There is still an unmet need for a floor mat that will allow for the drainage of water, salt, and other types of debris directly outside of the vehicle, while preventing the in-flow of liquid, fumes, and cold or hot air from outside of the vehicle, in a way that is easy, convenient, and safe to use and does not require the insertion or removal of a plug or cap.

### SUMMARY

The present invention satisfies the current unmet need for an improved floor mat that is convenient, easy, and safe to use at all times of the year. Moreover, the self-draining floor mat made according to the principles of the present invention contains a drain that drains unwanted debris out of the vehicle. Importantly the drain of the self-draining floor mat is made with a no-return flow valve, which allows liquid and other debris to flow freely from the vehicle while preventing dangerous and other fumes, water, noise, and cold or hot air from entering the vehicle.

The present invention satisfies the current unmet need for an improved floor mat that is convenient, easy, and safe to use at all times of the year. Moreover, the self-draining floor mat made according to the principles of the present invention contains a drain that drains unwanted debris out of the vehicle. Importantly the drain of the self-draining floor mat is made with a no-return flow valve, which allows liquid and debris to flow freely from the vehicle while preventing dangerous and other fumes, water, noise, and cold or hot air from entering the vehicle.

The self-draining floor mat protects the feet or shoes of persons using the vehicle from rain water and from melting ice, slush, and/or snow, which is especially important when the ice, slush, and/or snow contains salt. During cold-weather salt-laden moisture often causes permanent staining of shoes and boots. Moreover, the self-draining floor mats protect the floor of vehicles from moisture, salt, and other debris. Especially in colder climates, moisture and/or salt-laden moisture is the cause of rusting of the floors of vehicles. Once rusting has created an opening in the floor of a vehicle, the vehicle may not only become unsafe to drive and difficult to maintain, but a considerable loss of value will occur.

In more detail, invention is a self-draining, no-return flow, floor mat, which consists of a floor mat with a no-return flow valve drain. The drain is attached by either a vehicle owner or a vehicle manufacturer, to an opening in the floor mat that is made to accept such a drain. The drain is functionally positioned through the floor of the vehicle to provide for liquid and other debris to drain, as and when needed, to the exterior of the vehicle. Importantly, a no-return flow valve contained in the drain provides for outflow of liquid and debris from the floor mat to the exterior of the vehicle while preventing any back-flow of debris, liquid, or cold or hot air. The no-return flow valve is comprised of a valve body and a back-flow prevention means that allows unimpeded outflow of material from the floor mat to the exterior of the vehicle, while preventing backflow. In addition, the floor mat is available for use in automobiles, trucks, or vehicles with and without a floor divider mound. The self-draining floor mat is also useful in other trailers, houses on stilts, and the like. The material from which the floor mat is made is resistant to mold and mildew and, additionally, is available with or without an anti-bacterial substance that is either on or impregnated with the material. The floor mat is also available with a slow-release air freshener that is contained in the material from the mat is made. The mat material is made from material that remains pliable under all environmental conditions, is stain-resistant, and is easy to clean.

The present invention also teaches a method for making a no-return flow, self-draining, floor mat. Making the floor mat according to the principles of the present invention requires a floor mat to be styled with a lip about some or its entire periphery. The lip serves to assure that debris on the mat stays on the mat and does not come into contact with the floor of the vehicle. Making the mat from a pliable material ensures ease of installation and a tight fit between the bottom of the mat and the floor surface of the vehicle to ensure nearly instant drainage of debris into the drain which is located exactly at the lowest point of the vehicle floor. Using a molding process, such as an injection molding process, to manufacture the mat provides for a mat that is pliable, shaped as desired, and is attractively price-able. When desired, such as when the floor of the vehicle does not tilt in a direction that is amendable for gravity flow to drain the mat, the mat is formed with wedge-shaped protuberances on its underside providing the desired tilt. The drain is then affixed to an aperture of the mat and positioned so as to pass through the floor of the vehicle providing for the drain's outflow to exit to the exterior of the vehicle keeping the mat and shoes of the vehicles occupants dry. In one embodiment the mat is custom designed so that the drain aperture, and thus the drain, is situated at the lowest point of the vehicle floor providing for gravity flow of any accumulated moisture or other debris from the mat to beneath the vehicle. The drain is provided with a no-return valve providing for the outflow from the floor mat to the exterior of the vehicle while preventing back-flow. This feature is especially important in that it safeguards not only against moisture, such as rain and snow, from entering the vehicle, but against the danger of having exhaust fumes entering into the vehicle through the floor. If the drain did not have a no-return valve and a user forgot, or was unable, to cap the drain, the consequences could be deadly, as well as being inconvenient. The no-return valve means that a driver will never have to remember to remove or replace a drain cover. More importantly, a driver will never have to remove or replace a drain cover while driving. The no-return valve, which is an essential part of the present invention, comprises a valve body and a back-flow prevention means that allows for unimpeded outflow of material from the floor mat to the exterior of the vehicle, while preventing backflow. There are many kinds of no-return flow valves that are well-known and need not be discussed in further detail herein. The self-draining floor mats of the present invention may be shaped for use in automobiles and trucks that have, or do not have, a center dividing mound on the floor of the vehicle. In addition, the method for making contemplates making the floor mat from material that is resistant to bacteria, mold, and mildew and that contains an air-freshener.

Moreover, the self-draining, no reflux floor mat, as taught may be installed by a vehicle manufacturer and offered as an accessory in a new car or may be obtained in kit form providing for self-installation or for installation by an auto mechanic.

The present invention provides for all of the above described accomplishments by providing for a no-return flow, self-draining, floor mat, comprising:
a) a floor mat means;
b) a drain means connected to the floor mat means, the drain means operatively positioned for draining to the exterior of the vehicle, and
c) a no-return flow valve means functionally connected to the drain means providing for a no-return flow drain means,
   wherein the no-return flow drain means provides for outflow from the floor mat to the exterior of the vehicle while preventing back flow.

In a preferred embodiment the no-return flow valve means further comprises:
a) a valve body, and
b) a back flow prevention means coupled with the valve body, wherein the back flow prevention means provides for unimpeded outflow of material from the floor mat to the exterior of the vehicle, while preventing backflow.

In yet another embodiment, the self-draining floor mat is shaped for use in automobiles and may also be shaped for use in trucks and in vehicles with a middle dividing floor mound.

It is further contemplated that a preferred embodiment further comprises a floor mat that is resistant to mold and mildew and contains an anti-bacterial agent. A preferred embodiment is further contemplated to contain an air-freshener.

It is further contemplated that a preferred embodiment further comprises a floor mat, that is made of a pliable material, such as plastic or rubber.

The present invention also provides for a method of making a no-return flow, self-draining, floor mat, comprising the steps of:
a) providing for a floor mat means having a drain means having a no-return flow means, and
b) operatively positioning said floor mat means having a drain means having a no-return flow means on the floor of a vehicle providing for fluid and other debris to drain from the floor mat to the exterior of the vehicle,
   wherein the no-return flow drain means provides for outflow from the floor mat to the exterior of the vehicle while preventing back flow.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended and appreciated, the invention will now be described, by way of example, with reference to specific embodiments thereof which are illustrated in appended drawings wherein like reference characters indicate like parts throughout the several figures. It should be understood that these drawings only depict preferred embodiments of the present invention and are not therefore to be considered limiting in scope, thus, the invention will be described and explained with additional specificity and detail through the use of the accompanying drawings, in which:

FIG. 1 is a perspective view of the top side of a self-draining floor mat of the present invention.

FIG. 2 is a sectional view of a self-draining floor mat functionally positioned on a floor.

FIG. 3 is an exploded view of a cut-out of the self-draining floor mat and no-return valve fitted drain protrusion, as shown in FIG. 1.

FIG. 4 is a close-up sectional view of a no-return valve fitted drain in a no in-flow position.

FIG. 5 is a flow chart depicting the method for making a no-return valve fitted drain floor mat for use in vehicles.

### A LIST OF THE REFERENCE NUMBERS AND PARTS OF THE INVENTION TO WHICH NUMBERS REFER

10 A self-draining floor mat according to the principles of the present invention.
12 Raised lip of floor mat.
14 Aperture in floor mat leading to cylindrical protrusion 18 for receiving and containing no-return valve.
16 Surface of floor mat.
18 Cylindrical protrusion for receiving and containing no-return valve.
20 No-return valve which comprises valve sleeve 21 and diaphragm 24.
21 Valve sleeve or casing.
22 Aperture.
24 Valve diaphragm or, what is often referred to as a, membrane.
26 Valve diaphragm attachment means.
28 Screw-like attachment means having a flared and/or tapered extension.
29 Valve sleeve wall.
30 Floor on which self-draining floor mat is positioned.
32 Cylindrical opening in floor for receiving 18.
   Definitions
   Antibacterial and/or antimicrobial, as used herein, refers to substances that destroy or suppresses the growth of bacteria, mold, and mildew or their ability to reproduce. Such substances include metals and antimicrobial surfactants.
   Backflow, as used herein, refers to the movement of any materials including fumes, hot or cold air, liquid, gasoline, debris, or any other foreign substance from outside the vehicle through a valve body of a drain past the diaphragm into the vehicle.
   No-return flow, as used herein, refers to a flow that is restricted to move in one direction only. Herein, a no-return flow drain fitted with a no-return flow valve provides for one way movement (i.e., unidirectional flow) of any and all materials, including fumes, hot or cold air, liquid, debris, or any other substance from the interior of a vehicle through the no-return valve of the drain to the exterior of the vehicle, where the no-return valve prevents movement of any substance or gas in a reverse direction (i.e., back into the vehicle).
   Outflow, as used herein, refers to the movement of liquid, debris and any other material through the no-return valve fitted drain to the exterior of the vehicle.
   In-flow, as used herein, refers to the movement of liquid, debris, fumes and any other material from the exterior to the interior of a vehicle, which flow is prevented by the no-return valve that is fitted into the drain of the floor mat.
   No-return Valve, as used herein, refers to the valve means that allows for the outflow of materials to the exterior of the vehicle and prevents the backflow of materials to the interior of the vehicle, which valve may exist in many well-known and yet to be known shapes, sizes, and forms.

It should be understood that the drawings are not necessarily to scale. In certain instances, details which are not necessary for an understanding of the present invention or which render other details difficult to perceive may have been omitted.

### DETAILED DESCRIPTION

Referring now, with more particularity, to the drawings, it should be noted that the disclosed invention is disposed to embodiments in various sizes, shapes, and forms. Therefore, the embodiments described herein are provided with the understanding that the present disclosure is intended as illustrative and is not intended to limit the invention to the embodiments described herein.

The present invention is directed towards a no-return flow, self-draining, floor mat that is especially useful for vehicular floors. The self-draining floor mat comprises a floor mat having a cylindrical protrusion emanating from an aperture in the floor mat for receiving and holding a no-return flow valve to provide the function of a drain by providing the means for liquid and/or debris to flow freely from the surface of the floor mat, while preventing fumes, dangerous or otherwise, liquid, noise, and cold or hot air from back-flowing into the vehicle. An important feature of the invention is that its use eliminates the need for a drain cover. In turn, this eliminates the dangers that are presented when a driver removes or replaces a drain cover while driving. Thus, the present invention provides the means and a method for drivers to maintain a dry vehicle floor to reduce the occurrence of rust forming on the floor and to prevent shoes of the driver and passengers from becoming stained and soiled. Of course, the floor being drained by the floor mat is also useful for draining floors of buildings, as well as of vehicles.

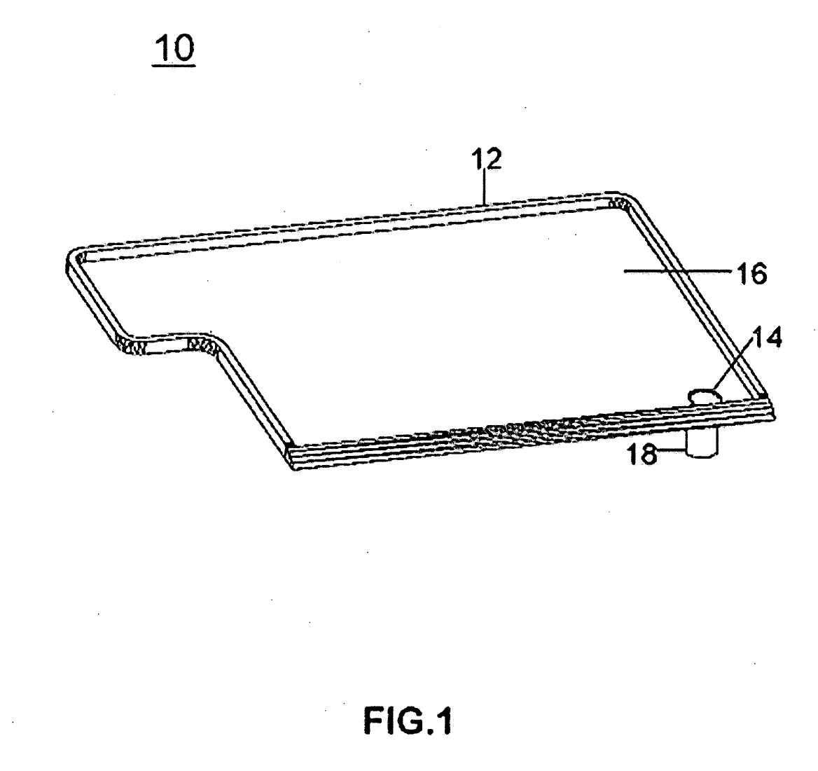

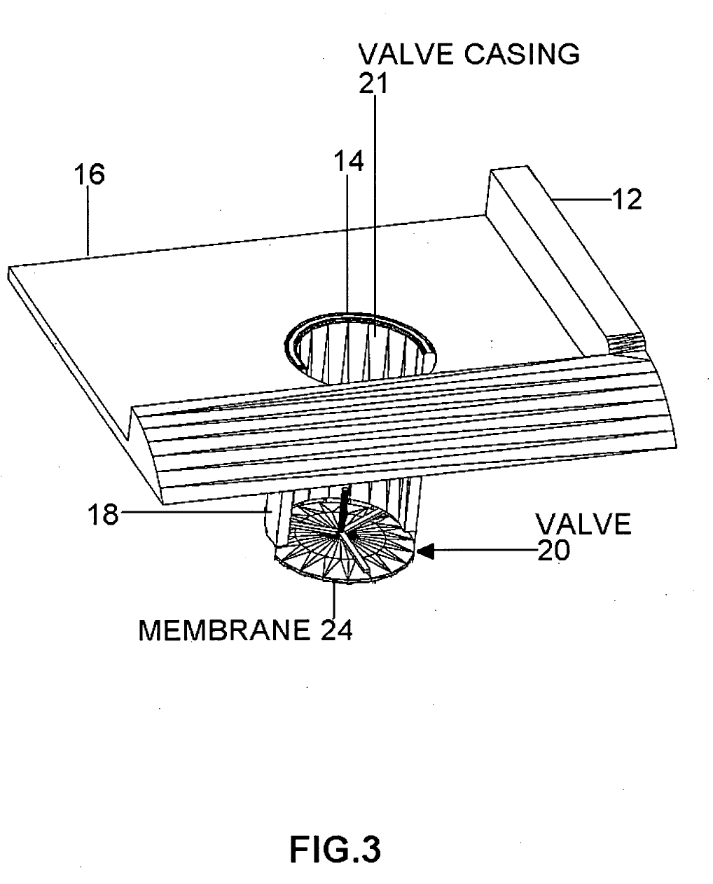

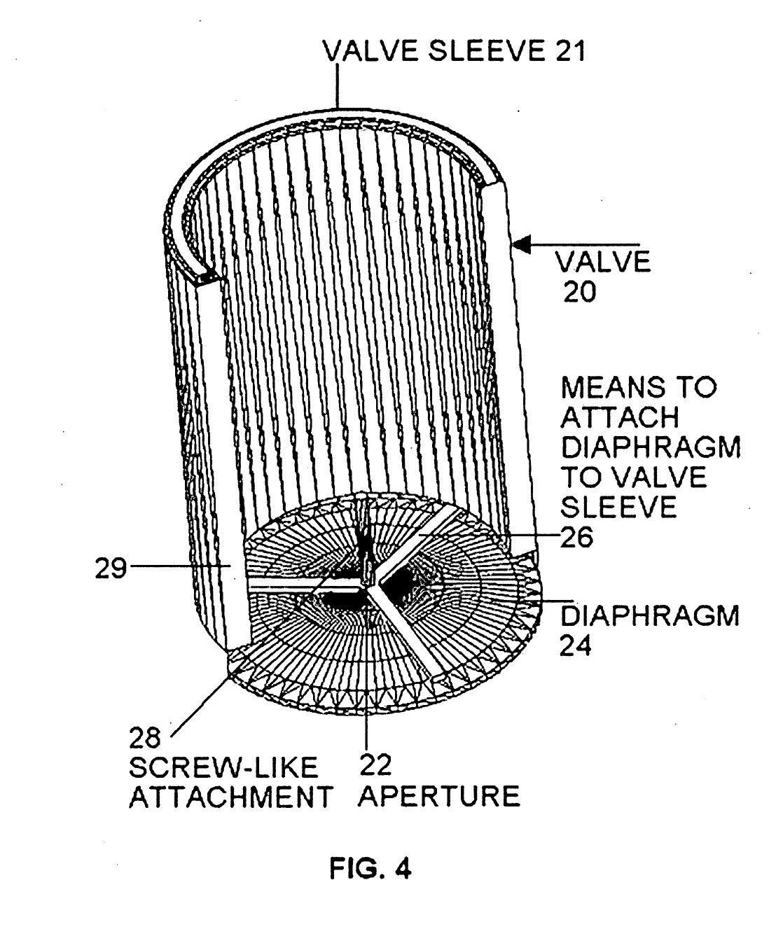

Turning now to the drawings, FIG. 1, a perspective view of the present invention, illustrates the top side of self-draining floor mat 10 having surface 16 fitted with aperture 14 opening to cylindrical protrusion 18 for receiving and containing a no-return valve (see FIGS. 3 and 4 for illustrations of the no-return valve). Cylindrical protrusion 18, ideally, is molded as a single piece with floor and lip of the floor mat, and is functionally positioned, in this particular embodiment, in a corner of the floor mat. As the drawing indicates, the drain is positioned and attached to the floor mat so that liquid and other debris is compelled by gravity to travel to the drain to be discharged through the floor board to the exterior of the vehicle. It is to be understood that the drain aperture and the drain are positioned to be located at the lowest part of a vehicle's floor. Liquid and/or other debris, such as melting ice or snow, is contained on the mat by raised lip or flange 12 that is optionally placed about the perimeter of the floor mat. Most importantly, the no-return flow valve provides for the outflow of liquid and/or debris from the floor mat to the exterior of the vehicle while precluding any back flow of debris, water, or cold or hot air.

Moreover, the floor mat is available shaped for use in vehicles, such as automobiles or trucks and, if desired, is available for use in vehicles with a floor divider mound. In addition to keeping vehicle floors clean and dry, the floor mat also is available in models that are self-maintaining in that they are resistant to mold and mildew to prolong the life of the mat while also reducing the possibility of odor and maintaining sanitary conditions. Such resistance is, in part, provided by the mold and mildew resistant nature of the material that is used to make the floor mat. Such materials may include suitable compositions of plastic or rubber. The mat is made by a suitable molding process, such as injection molding that provides a mat that is pliable, shaped as desired, and is attractively priced. The casting-mold used to make the mat is designed to produce the floor part of the mat, the rim, if desired, the aperture, and the protuberance that is used to hold the no-return flow valve. When desired, such as when the floor of the vehicle does not tilt in a direction that is amendable for gravity flow to drain the mat, the mat is formed with wedge-shaped protuberances, or the like, that are either added or removed on its underside providing for the desired tilt. Once the protuberance is positioned so as to pass through an aperture provided in the floor of the vehicle and a no-return flow valve is securely positioned within the protuberance, the self-draining floor mat is ready to provide for debris outflow to exit to the exterior of the vehicle keeping the mat, the vehicle floor, and the shoes of the vehicles occupants dry. Additionally, vehicle floor mats made according to the principles of the present invention, may be impregnated with an anti-bacterial substance that provides additional protection against the growth of mold and mildew and also protects against the formation of unpleasant odors. Floor mats according to the teachings of the present invention are also available with impregnated time-released air fresheners. The materials from which the mats of the present invention are made are pliable to ensure a close fit between the mat and the floor.

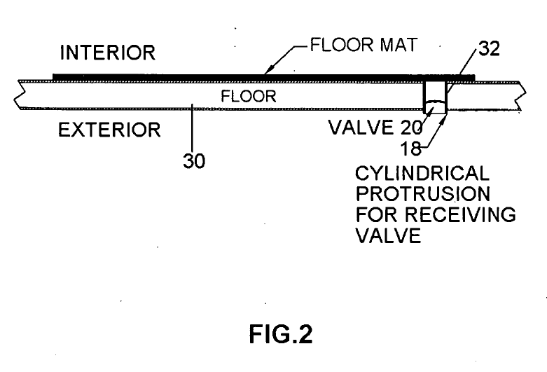

FIG. 2, a sectional view of a self-draining floor mat, illustrates a favored embodiment of the self-draining floor mat made according to the principles of the present invention. Floor mat 10 is positioned on the interior side of the floor. Cylindrical protrusion 18 of floor mat 10 is shown functionally positioned within cylindrical opening 32 that has been made in floor 30. FIG. 2 further indicates the presence of no-return flow 20 fitted within cylindrical protrusion 18 providing for a no-return flow drain. As illustrated the self-draining floor mat is ready for draining any unwanted liquid and/or other debris to the outside of the vehicle.

FIG. 3 is an exploded view of a cut-out of the self-draining floor mat and no-return valve fitted drain, as shown in FIG. 1. This drawing indicates how flange 12 retains the liquid and debris within the confines of the floor mat so that the liquid and debris may be directed by gravity to flow into cylindrical protrusion 18 in which no return valve 20 is contained. FIG. 3 and FIG. 4 illustrate exemplary no-return valve 20 comprising valve sleeve 21 and back flow prevention means, diaphragm 24. Liquid and/or debris flowing into valve sleeve 21 are passed through diaphragm 24 to exit to the exterior.

In general, no-return flow valves provide for unimpeded outflow of material, while preventing backflow. The variety of no-return flow valves are well known by those of ordinary skill in the art and need not be discussed further here. A person with skill in the art would be familiar with the many different no-return valve designs, including a valve spring design no-return flow valve. This invention encompasses the use of any no-return valve and does not rely on just those indicated in the drawings. In addition, the materials used for the no-return valve may different greatly and include, but are not limited to metal, plastic, and ceramic, for example. The choice of material used may depend on the design chosen and/or the material that is used to manufacture the floor mat. Once any one of the known or yet to be known models of no-return valve is securely emplaced within the confines of protuberance 18 of floor mat 10, the self-draining floor mat is ready to provide for all liquid and/or other debris that is on the surface of the floor mat to drain to the exterior of the vehicle.

In particular, FIG. 4, a close-up sectional view of an exemplary no-return valve fitted within cylindrical protrusion 18, illustrates the components of the exemplary no-return valve used to illustrate the invention. No-return valve 20 comprises valve sleeve 21 molded together with rigid valve diaphragm attachment means 26 as a one-piece unit. Valve diaphragm is comprised of a flexible material that allows the diaphragm to flex and bend when the weight of liquid and/or debris draining through the valve impinges upon the diaphragm. Valve diaphragm 24, or what is often referred to as a membrane, is firmly attached to valve sleeve 21 by means of valve diaphragm attachment means 26. Valve diaphragm attachment means 26 is provided with centrally located aperture 22 and screw-like attachment means 28. Valve diaphragm 24 is attached to valve sleeve 21 by situating valve diaphragm 24 beneath attachment means 26 and securing the diaphragm in place by the use of screw-like attachment means 28. When liquid and/or debris impinge upon the diaphragm it bends outwardly to allow the liquid and/or debris to pass through to the outside of the vehicle. However, rigid valve diaphragm attachment means 26 and valve sleeve wall 29 prevents the flexible diaphragm from bending or flexing inward, thus preventing the inflow of air, other gases, liquid, and/or other debris. FIG. 4 depicts the no-return valve drain in the no-inflow or closed position.

The use of a no-return valve drain in a self-draining floor mat is unique in that it allows for removal of liquid and/or other debris in a completely safe and convenient manner. In addition, when valve diaphragm 24 is in the closed position as depicted in FIG. 4, it protects the vehicle inhabitants from cold air and potentially dangerous fumes from entering the vehicle. The closed position of diaphragm 24 as depicted in FIG. 4 is the position valve diaphragm 24 will assume in the absence of any liquid or debris. Another major benefit of having a no-return flow drain embedded through the mat and the vehicle floor to provide for unwanted liquid and other debris to drain to the outside of the vehicle, is that unlike prior attempts, the floor mat will not need to be removed periodically so that the contents of the drain can be cleaned. Because the drain allows debris and liquid to exit directly through, for instance a vehicle floor, users will never have to remove such debris manually. And, importantly, the self-opening and closing feature of a no-return flow valve provides for a self-draining floor mat that does not require a capping means, saving a driver and the occupants of a vehicle the danger that is present when a driver's attention is diverted to removing or replacing a drain cover.

As indicated in the drawings and mentioned above, the use of the invention requires a hole in the floor that leads from the interior side of the floor to the exterior side of the floor providing for cylindrical protrusion 18 to extend below the floor to the exterior.

To use this invention with a vehicle, the user must either purchase a vehicle or trailer where the floor mat has been installed at the time of the vehicle's manufacture, by a body shop, or by a person having some degree of automotive skill. Where the floor mat is installed at the time of the vehicle's manufacture, the car body will have aperture 32 drilled into the body as part of its manufacture, and the mat will be placed as in the method described below. Where the user has the floor mat installed by an auto body shop, the shop will first drill an aperture, such as aperture 32, in the vehicle floor for the insertion of cylindrical protrusion 18 through the aperture at the time the floor mat is positioned on the floor. The no-return valve may be securely inserted into cylindrical protrusion 18 before or after cylindrical protrusion 18 is positioned through the aperture drilled through the vehicle floor. Once the floor mat is installed, no special maintenance is necessary, and floor mat will provide for the safe removal of liquid and debris without any further effort on the part of the user.

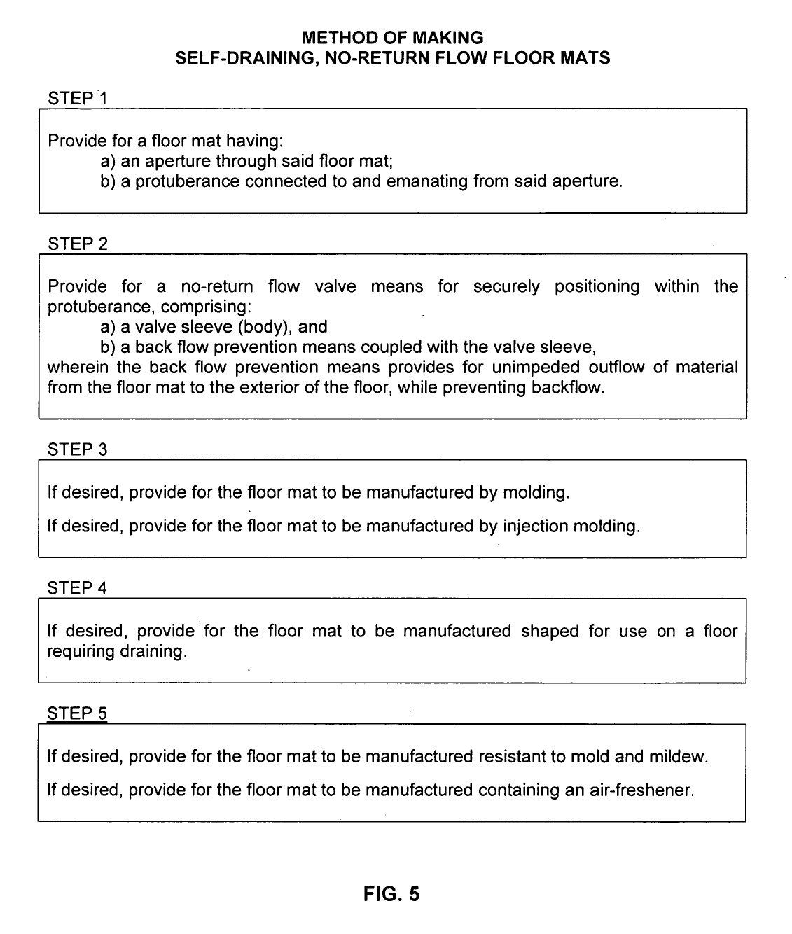

This invention further comprises a method of making a self-draining, no-return flow, self-draining, floor mat. The method for making a no-return flow self-draining floor mat is depicted in FIG. 5. The first step is to make the floor mat, preferably by a molding technique, such as by injection molding. It is contemplated that the mat be molded of a pliable material. It is further contemplated that the mat be molded having an optional raised lip or flange about the perimeter of the mat and having a cylindrical protrusion. One method of molding is injection molding. One the mat is formed the next step is to insert a no-return flow valve sized for secure insertion into the cylindrical protrusion that is fitted for securely receiving and maintaining the valve providing means for outflow of liquid and/or debris from the interior floor mat to the exterior while preventing back flow. In the method of making a self-draining floor mat, the floor mat may be shaped for use in automobiles, trucks, and/or in vehicles that have a center floor dividing mound. In addition, the method of making as taught herein calls for a floor mat that is resistant to mold and mildew and that contains an air-freshener. Air-fresheners and anti-bacterial agents, for the prevention of mold and mildew, for example, may be impregnated into the pliable rubber or plastic at the time of their making. Adding slow, time-release compositions to a material, such as plastic and rubber, is a well-known art and need not be discussed further here. In light of the extensive flooding recently suffered by coastal residents from unusually strong hurricane activity, it is evident that one use for the self-draining mat would be in the draining of such flood waters from the floors of flooded homes, which would include trailer homes and houses built on stilt-like supports.

The foregoing description, for purposes of explanation, uses specific and defined nomenclature to provide a thorough understanding of the invention. However, it will be apparent to one skilled in the art that the specific details are not required in order to practice the invention. Thus, the foregoing description of the specific embodiment is presented for purposes of illustration and description and is not intended to be exhaustive or to limit the invention to the precise form disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is:

1. A self-draining, no-return flow floor mat, comprising:
a) a floor mat for a floor, said floor mat having a drain means connected to said floor mat, said drain means operatively positionable through a floor providing for outflow from said floor mat to the exterior of a floor, and
b) a no-return flow valve functionally affixable within said drain means providing for outflow from said floor mat to the exterior of the floor while preventing back flow into an interior of the floor.

2. The self-draining, no-return flow floor mat, as recited in claim 1, wherein said no-return flow valve means further comprises:
a) a valve body, and
b) a back flow prevention means coupled with said valve body,
wherein said back flow prevention means provides for unimpeded outflow of material from the floor mat to the exterior of the vehicle, while preventing backflow.

3. The self-draining, no-return flow floor mat, as recited in claim 1, wherein said back flow prevention means further comprises a membrane.

4. The self-draining, no-return flow floor mat, as recited in claim 1, further comprising wherein said floor mat is shaped for use in automobiles.

5. The self-draining, no-return flow floor mat, as recited in claim 1, further comprising wherein said floor mat is shaped for use in trucks.

6. The self-draining, no-return flow floor mat, as recited in claim 1, further comprising wherein said floor mat further is shaped for use in a floor requiring draining.

7. The self-draining, no-return flow floor mat, as recited in claim 1, further comprising wherein said floor mat is resistant to mold and mildew.

8. The self-draining, no-return flow floor mat, as recited in claim 1, further comprising wherein said floor mat contains at least one anti-bacterial.

9. The self-draining, no-return flow floor mat, as recited in claim 1, further comprising wherein said floor mat contains an air-freshener.

10. The self-draining, no-return flow floor mat, as recited in claim 1, further comprising wherein said floor mat is made of a pliable material.

11. The self-draining, no-return flow floor mat, as recited in claim 10, further comprising wherein said floor mat is made of plastic.

12. The self-draining, no-return flow floor mat, as recited in claim 10, further comprising wherein said floor mat is made of rubber.

13. A method of making a self-draining, no-return flow floor mat, comprising the steps of:
a) providing a floor mat for placement on an interior surface of a floor, said floor mat having a drain means, said drain means operatively positionable through the floor providing for outflow from said floor mat to an exterior of the floor, and
b) providing a no-return flow valve functionally affixable within said drain means providing for outflow from an interior of said floor mat to the exterior of the floor while preventing back flow into an interior of the floor.

14. The method of making a self-draining floor mat, as recited in claim 13, wherein said drain means further comprises:
a) an aperture through said floor mat;
b) a protuberance connected to and emanating from said aperture,
wherein said no-return flow valve means is positionable within and securely containable by said protuberance.

15. The method of making a self-draining floor mat, as recited in claim 13, wherein said no-return flow valve means further comprises:
a) a valve sleeve, and
b) a back flow prevention means coupled with said valve sleeve,
wherein said back flow prevention means provides for unimpeded outflow of material from the floor mat to the exterior of the floor, while preventing backflow.

16. The method of making a self-draining floor mat, as recited in claim 13 wherein providing said floor mat further comprises floor mat manufacture by molding.

17. The method of making a self-draining floor mat, as recited in claim 15 wherein said manufacture by molding further comprises injection molding.

18. The method of making a self-draining floor mat, as recited in claim 13, further comprising wherein said floor mat is resistant to mold and mildew.

19. The method of making a self-draining floor mat, as recited in claim 13, further comprising wherein said floor mat contains an air-freshener.

20. A self-draining, no-return flow floor mat, comprising:
a) a floor mat;
b) a drain means emanating from said floor mat operatively positionable through a floor providing for outflow from said floor mat to the exterior of a floor, and
c) a no-return flow valve functionally affixable within said drain means providing for outflow from the floor mat to the exterior of the floor while preventing back flow to an interior of the floor.
